(19) United States
(12) Patent Application Publication
(10) Pub. No.: US 2002/0185867 A1
(43) Pub. Date: Dec. 12, 2002

(54) Water heater connection system

(76) Inventor: Robert S. Stachowiak, Commerce, TX (US)

Correspondence Address: KONNEKER SMITH, 660 NORTH CENTRAL EXPRESSWAY, SUITE 230, PLANO, TX, 75074

(21) Appl. No.: 09/877,309

(22) Filed: Jun. 8, 2001

(51) Int. Cl. F16L 17/00

(52) U.S. Cl. 285/354; 285/334.5

(57) ABSTRACT

A water heater connection system, in a described embodiment thereof, provides insulation between a connector threaded nut and a flow tube, and isolation of a flow tube end from gas accumulated in the flow tube. The connection system provides insulation between metallic components, if needed for prevention of galvanic corrosion, and protection of the flow tube end from corrosion due to gas in the flow tube.

### BACKGROUND

The present invention relates generally to water heater connections in water supply systems and, in an embodiment described herein, more particularly provides a water heater connection system.

Metallic water heater connections, such as those utilizing a corrugated copper flow tube, are sometimes susceptible to failure due to corrosion. This problem is particularly acute in areas such as southern California and southern Texas. The corrosion generally leads to failure of the flow tube near an end of the tube.

Various solutions to the problem have been proposed. Each of the solutions, however, presupposes that the cause of the corrosion is due to the close proximity of dissimilar metals leading to galvanic corrosion or electrolysis. Thus, these solutions have focused on insulating various components of a water heater connection system from each other.

In one system, a copper flow tube is connected to a galvanized water supply pipe using a brass connector nut. An internal washer seals between the flow tube and the pipe, also providing insulation between the flow tube and the pipe. An external sleeve between the nut and the flow tube provides insulation between these components. An example of this type of connection system is found in U.S. Pat. No. 3,501,171.

In another more recently developed system, an insulating inner sleeve extends within the end of the flow tube. The inner sleeve seals between the flow tube and the pipe, and prevents direct contact between these components. An example of this type of connection system is found in U.S. Pat. No. 5,169,180.

This patent describes the insulating sleeve as providing enhanced protection against galvanic corrosion, presumably because it creates a longer path through the fluid in the flow tube for electrical conduction between the flow tube and the pipe. Longitudinal ribs formed on an exterior of the inner sleeve grip the flow tube and space the inner sleeve body away from an interior surface of the flow tube. However, in this design the nut is not insulated from the flow tube, but is in direct contact therewith. Thus, the nut serves as an electrical connection between the copper flow tube and the pipe, thereby allowing galvanic corrosion to still occur with this design.

Therefore, it may be readily seen that an improved water heater connection system is needed.

### SUMMARY

In carrying out the principles of the present invention, in accordance with an embodiment thereof, a water heater connection system is provided which is an improved solution to the problem of flow tube corrosion. In the disclosed water heater connection system, a flow tube is insulated from a connector nut and from a water supply pipe, while an end of the flow tube is isolated from gas which may accumulate in the flow tube.

In one aspect of the invention, a water heater connection system is provided which includes a tubular flow tube having an outwardly flared end, a tubular inner sleeve having a radially enlarged end, a tubular outer sleeve having a radially enlarged end and a threaded nut operative to urge the outer sleeve enlarged end against the flow tube flared end. The inner sleeve is received within the flow tube, and the flow tube is inserted through the outer sleeve. The flow tube flared end contacts, and is axially engaged between, the inner sleeve enlarged end and the outer sleeve enlarged end. The outer sleeve insulates the nut from contact with the flow tube.

Preferably, the inner sleeve isolates an end of the flow tube, opposite its attachment to a water heater, from gas within the flow tube. Thus, where the flow tube is connected between a water heater and a hot water supply pipe, the end of the flow tube at the water supply pipe end is isolated from gas in the flow tube by the inner sleeve. The inner sleeve internally overlies the flow tube and protects a circumferential interior surface area of the flow tube end from contact with the gas.

Furthermore, the inner sleeve is preferably constructed of a crosslinked polyethylene material. This material has been shown to possess superior high temperature properties. The material is well suited for use as a seal between the flow tube and pipe, and for isolation of the flow tube end from the gas.

These and other features, advantages, benefits and objects of the present invention will become apparent to one of ordinary skill in the art upon careful consideration of the detailed description of a representative embodiment of the invention hereinbelow and the accompanying drawings.

### BRIEF DESCRIPTION OF THE DRAWINGS

FIG. 1 (Prior Art) is a partially cross-sectional view of a first prior art water heater connector;

FIG. 2 (Prior Art) is a partially cross-sectional view of a second prior art water heater connector;

FIG. 3 is a partially cross-sectional view of a water heater connection system embodying principles of the present invention; and

FIG. 4 is an elevational view of the water heater connection system of FIG. 3, wherein a flow tube with connectors is connected between a water heater and a water supply pipe.

### DETAILED DESCRIPTION

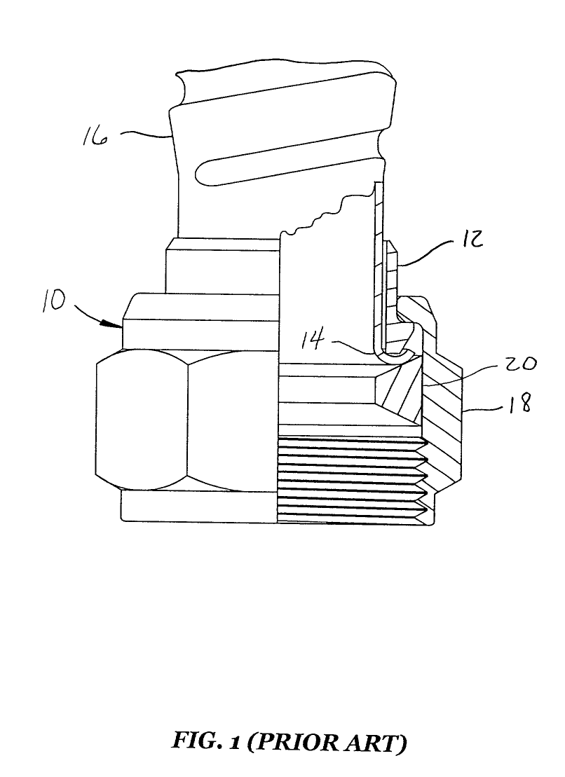

In FIG. 1 is representatively illustrated a water heater connector 10 of one type improved upon by the present invention. U.S. Pat. Nos. 3,501,171 and 3,346,274 further describe examples of this type of connector. As set forth in those patents, this connector design 10 is directed toward providing electrical insulation between components of the connector, to thereby prevent or minimize galvanic corrosion of the connector.

For this purpose, the connector is provided with a “dielectric” sleeve 12 interposed between a flared end 14 of a flow tube and a nut 18 of the connector. The sleeve 12 prevents direct contact between the nut 18 and the flow tube 16. The sleeve 12 does not conduct electricity, and thus prevents electric current from flowing between the nut and flow tube. An internal ring-shaped washer 20 provides a seal between the flared end 14 and a pipe, nipple, etc. (not shown) to which the nut 18 is threaded.

Note that the flared end 14, and the remainder of the interior of the flow tube i6, is exposed to all liquids, gases, etc. flowing through the flow tube. In addition, a crevice is formed between the flared end 14 and the washer 20, which serves as a location for corrosive gases to collect.

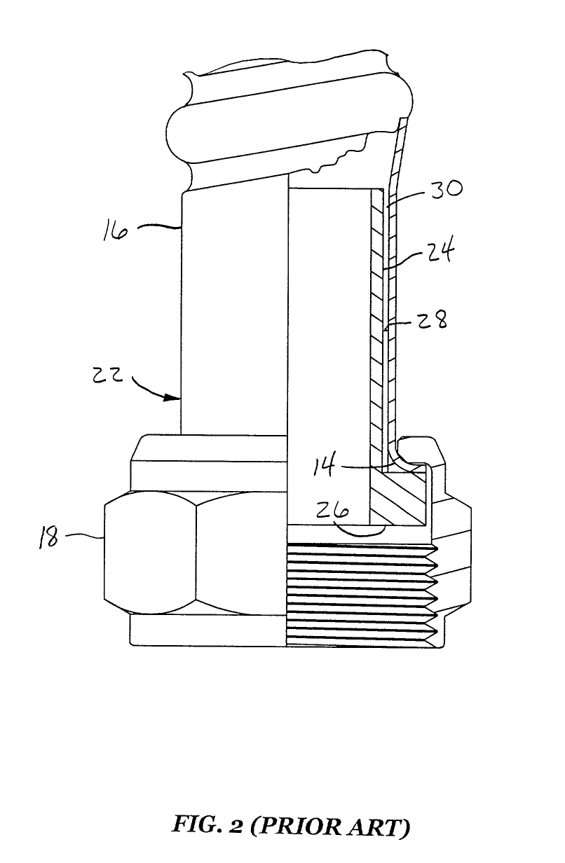

In FIG. 2 is representatively illustrated another connector 22 of a type improved upon by the present invention. An example of this type of connector is further described in U.S. Pat. No. 5,169,180. This connector design is also directed toward preventing galvanic corrosion of the flow tube 16, but does so in an entirely different manner as compared to the connector design shown in FIG. 1.

Instead of insulating the nut 18 from the flow tube 16, these components are placed in direct contact. No dielectric sleeve separates these components. Thus, electric current may flow between the flow tube 16, the nut 18 and any pipe, nipple, etc. threaded to the nut.

Protection against galvanic corrosion is purportedly provided by an inner sleeve 24 which extends into the flow tube 16. Perhaps the theory is that the sleeve 24 provides a longer path for current flow through the fluid in the flow tube 16 between the flow tube and whatever pipe, nipple, etc. is threaded to the nut 18. However, the length of the inner sleeve is not sufficient to prevent current flow in high conductivity water and therefore, galvanic corrosion may still occur in this design between dissimilar metals.

Another expressed benefit of the connector 22 design is that the inner sleeve 24 is integrally combined with a washer 26. Longitudinal ribs 28 are used to provide a gripping engagement between the inner sleeve 24 and the flow tube 16, to prevent the inner sleeve/washer from falling out of the flow tube.

Note that the ribs 28 space the inner sleeve 24 radially away from the flow tube 16, forming an annular volume 30 therebetween. Thus, the flared end 14, and the remainder of the interior of the flow tube 16, is exposed via the annular volume 30 to all liquids, gases, etc. flowing through the flow tube.

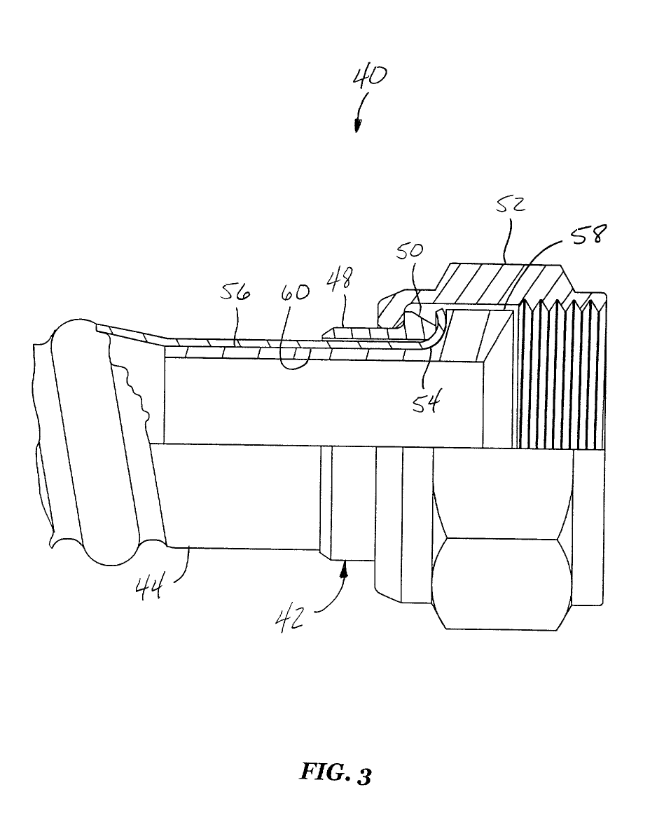

Turning now to FIG. 3, therein is representatively illustrated a water heater connection system 40 which embodies principles of the present invention. In the following description of the connection system 40, directional terms are used only for convenience in referring to the accompanying drawings. Additionally, it is to be understood that the embodiment of the present invention described herein may be utilized in various orientations, such as inclined, inverted, horizontal, vertical, etc., and in various configurations, without departing from the principles of the present invention.

The connection system 40 is unique in that it provides protection against galvanic corrosion in a connector 42, while also providing protection against corrosion due to gas or other corrosive fluid which accumulates in a flow tube 44.

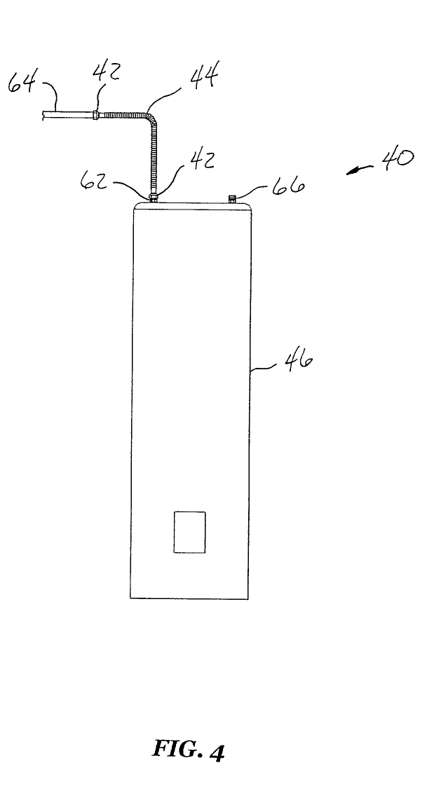

The present applicant has discovered that flow tube corrosion can be caused by gases which originate in a water heater 46 (see FIG. 4). Specifically, these gases may evolve in the water heater 46 tank from chemical reactions between the water and the water heater protective anode. These gases rise in the water and collect in the crevice between the sealing washers 20, 26 and flow tube flared ends 14 of conventional connectors 10, 22.

The gases cause corrosion of the flow tube flared end 14, particularly on the hot water discharge side of the water heater. The cold water side is generally protected from the gases by its dip tube which extends to near the bottom of the water tank, preventing the gases from collecting therein.

In addition, the corrosion is generally greatest on the end of the flow tube farthest away from the water heater, that is, the end connected, for example, to the hot water supply pipe of a building, etc., to which the water heater supplies hot water. This end of the flow tube (the end opposite the water heater) is generally at a higher elevation than the end connected to the water heater, and the gases accumulate more readily at the higher elevation.

The connector 42 provides protection against galvanic corrosion by using an outer sleeve 48 on the flow tube 44. The sleeve 48 has an enlarged end 50 interposed axially and radially between a threaded nut 52 and a flared end 54 of the flow tube 44. The sleeve 48 prevents contact both radially and axially between the nut 52 and flow tube 44, and is insulative, thereby preventing flow of electric current between the nut and flow tube.

The connector 42 provides protection against corrosion due to gas in the flow tube 44 by using a combined inner sleeve 56 and gasket 58. The inner sleeve 56 isolates an interior cylindrical surface area 60 of the flow tube 44 proximate the flared end 54 from gas or other corrosive fluid in the flow tube, preventing contact between the corrosive fluid and the surface area 60.

Preferably, the inner sleeve 56 has an outer diameter somewhat greater than an inner diameter of the flow tube 44 at the surface area 60. At assembly, the inner sleeve 56 is pressed into the flow tube 44. Thus, a press-fit is used between the inner sleeve 56 and the flow tube 44 to both secure the inner sleeve in the flow tube and prevent gas and/or corrosive fluid from contacting the surface area 60. Other means of preventing gas from contacting the surface area 60 could be used instead, such as an external seal on the inner sleeve 56, etc.

Another preferred construction of the inner sleeve 56 and washer 58 involves use of materials having excellent high temperature properties. Preferably, the inner sleeve 56 and washer 58 are formed as a single component, with the washer 58 being a radially enlarged portion thereof. This single component 56, 58 is preferably made of a crosslinked polyethylene material, which has superior high temperature properties. However, note that it is not necessary for the inner sleeve 56 and washer 58 to be integrally formed, or for either of them to be made of a crosslinked polyethylene material.

In FIG. 4 the connection system 40 is depicted with the flow tube 44 connected between a hot water outlet 62 of the water heater 46 and a hot water supply pipe 64 of a building, etc., to which hot water is being supplied. It is particularly preferred that the connector 42 be used to connect the flow tube 44 to the pipe 64, since this end of the flow tube is particularly susceptible to corrosion due to gas in the flow tube. However, the connector 42 may also be used to connect the flow tube 44 to the water heater outlet 62. In addition, the flow tube 44 and connector 42 may also be used on a cold water inlet 66 of the water heater 46 and/or on the connection to the cold water supply piping, if desired.

Of course, a person skilled in the art would, upon a careful consideration of the above description of a representative embodiment of the invention, readily appreciate that many modifications, additions, substitutions, deletions, and other changes may be made to this specific embodiment, and such changes are contemplated by the principles of the present invention. Accordingly, the foregoing detailed description is to be clearly understood as being given by way of illustration and example only, the spirit and scope of the present invention being limited solely by the appended claims and their equivalents.

What is claimed is:

1. A water heater connection system, comprising:
a generally tubular flow tube having an outwardly flared end;
a generally tubular inner sleeve having a radially enlarged end, the inner sleeve being received within the flow tube;
a generally tubular outer sleeve having a radially enlarged end, the flow tube being inserted through the outer sleeve;
the flow tube flared end contacting and being axially engaged between the inner sleeve enlarged end and the outer sleeve enlarged end; and
a threaded nut operative to urge the outer sleeve enlarged end against the flow tube flared end, and the outer sleeve insulating the nut from contact with the flow tube.

2. The water heater connection system according to claim 1, wherein the outer sleeve insulates the nut from contact with the flow tube in both radial and axial directions.

3. The water heater connection system according to claim 1, wherein the outer sleeve is positioned between the nut and the flow tube both radially and axially.

4. The water heater connection system according to claim 1, wherein the inner sleeve directly circumferentially engages an interior surface area of the flow tube proximate the flared end, thereby isolating the surface area from an accumulation of gases within the flow tube.

5. The water heater connection system according to claim 1, wherein the inner sleeve interiorly overlies a circumferential surface area of the flow tube, the inner sleeve directly contacting the surface area and isolating the surface area from gases within the flow tube.

6. The water heater connection system according to claim 1, wherein an outer cylindrical surface of the inner sleeve is press-fit into an inner cylindrical surface of the flow tube, thereby isolating the flow tube inner cylindrical surface from gas within the flow tube.

7. The water heater connection system according to claim 1, wherein at least a portion of the inner sleeve is constructed of a crosslinked polyethylene material.

8. The water heater connection system according to claim 7, wherein the enlarged end of the inner sleeve is constructed of the crosslinked polyethylene material.

9. The water heater connection system according to claim 7, wherein the entire inner sleeve is constructed of the crosslinked polyethylene material.

10. A water heater connection system, comprising:
a generally tubular flow tube having first and second opposite ends, at least one of the first and second ends being outwardly flared;
a flow tube connector including:
a generally tubular inner sleeve having a radially enlarged end, the inner sleeve being received within the flow tube,
a generally tubular outer sleeve having a radially enlarged end, the flow tube being inserted through the outer sleeve,
the flow tube flared end contacting and being axially engaged between the inner sleeve enlarged end and the outer sleeve enlarged end, and
a threaded nut operative to urge the outer sleeve enlarged end against the flow tube flared end, and the outer sleeve insulating the nut from contact with the flow tube; and
a water heater, the flow tube first end being attached to the water heater.

11. The water heater connection system according to claim 10, wherein the outer sleeve insulates the nut from contact with the flow tube in both radial and axial directions.

12. The water heater connection system according to claim 10, wherein the outer sleeve is positioned between the nut and the flow tube both radially and axially.

13. The water heater connection system according to claim 10, wherein the inner sleeve directly circumferentially engages an interior surface area of the flow tube proximate the flared end, thereby isolating the surface area from an accumulation of gases within the flow tube.

14. The water heater connection system according to claim 10, wherein the inner sleeve interiorly overlies a circumferential surface area of the flow tube, the inner sleeve directly contacting the surface area and isolating the surface area from gases within the flow tube.

15. The water heater connection system according to claim 10, wherein at least a portion of the inner sleeve is constructed of a crosslinked polyethylene material.

16. The water heater connection system according to claim 10, wherein the flow tube directs water flow between a hot water output of the water heater and a hot water supply pipe.

17. The water heater connection system according to claim 16, wherein the flow tube connector sealingly secures the flow tube second end to the hot water supply pipe.

18. The water heater connection system according to claim 17, wherein an accumulation of gas within the flow tube is isolated from the flared second end of the flow tube by the flow tube connector.

19. The water heater connection system according to claim 17, wherein the inner sleeve isolates a circumferential interior surface area of the flow tube proximate the flared second end from gas within the flow tube proximate the hot water supply pipe.

20. The water heater connection system according to claim 17, wherein an outer cylindrical surface of the inner sleeve is press-fit into an inner cylindrical surface of the flow tube second end, thereby isolating the flow tube inner cylindrical surface from gas within the flow tube proximate the hot water supply pipe.
